(19) United States
(12) Patent Application Publication
(10) Pub. No.: US 2007/0246452 A1
(43) Pub. Date: Oct. 25, 2007

(54) VARIABLE SPEED CONVECTION IN COOKING APPLICATIONS

(75) Inventors: Chris BLACKSON, Uniontown, OH (US); Daniel RUSHING, Clarksville, TN (US); Gary W. FISHER, Goodlettsville, TN (US)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS, INC., Cleveland, OH (US)

(21) Appl. No.: 11/745,069

(22) Filed: May 7, 2007

Related U.S. Application Data
(63) Continuation-in-part of application No. 11/737,293, filed on Apr. 19, 2007, now abandoned.
(60) Provisional application No. 60/745,244, filed on Apr. 20, 2006.

(51) Int. Cl. A21B 1/22

(52) U.S. Cl. 219/400

(57) ABSTRACT

A cooking appliance includes a cabinet forming an oven cavity, and bake and broil heating elements. A convection system develops a flow of heated air within the cavity. The convection system includes a motor-driven fan, a convection heating element, and a controllable switch for controlling an electrical power circuit for the motor. A user interface device allows user selections of convection bake and convection roast operations. A controller communicates with the interface device and controls activations of the fan and the heating elements. The controller has an output for controlling operations of the controllable switch. During convection baking, the controller activates the bake and convection heating elements and controls the controllable switch so that the fan runs at a first speed. During convection roasting, the controller activates the bake and convection heating elements and controls the controllable switch so that the fan runs at a second, higher speed.

### CROSS-REFERENCE TO RELATED APPLICATIONS

This application is a Continuation-In-Part of U.S. patent application Ser. No. 11/737,293 filed Apr. 19, 2007, which claims the benefit of U.S. Provisional Patent Application Ser. No. 60/745,244 filed Apr. 20, 2006, both of which are incorporated herein by reference in their entirety.

### BACKGROUND OF THE INVENTION

1. Field of the Invention

The present invention relates to appliances adapted for convection cooking.

2. Description of Related Art

A conventional oven uses radiant heating provided by bake and/or broil heating elements to cook food placed within the oven. A convection oven has a fan for developing convective air flows within the oven, and can cook food more quickly than a comparable conventional oven. However, certain baked goods, such as breads or cakes, may not bake well in a convection oven. For example, certain baked goods may develop an undesirable crust or outer glazing when baked in a convection oven. It would be useful to provide a convection oven for quickly cooking food while minimizing undesirable properties caused by the convection cooking process.

### BRIEF SUMMARY OF THE INVENTION

Provided is a cooking appliance including a cabinet forming an oven cavity, a broil heating element, and a bake heating element. A convection heating system develops a flow of heated air within the oven cavity. The convection heating system includes a motor-driven fan, a convection heating element located adjacent to the fan, and a controllable switch for controlling an electrical power circuit for the motor. A user interface device allows for user selections of a convection bake operation and a convection roast operation. A controller communicates with the user interface device. The controller controls activations of the fan and said heating elements. The controller has an output for controlling operations of the controllable switch. During the convection bake operation, the controller activates the bake and convection heating elements and controls the controllable switch so that the fan runs at a first speed. During the convection roast operation, the controller activates the bake and convection heating elements and controls the controllable switch so that the fan runs at a second speed that is higher than the first speed.

Further provided is a cooking appliance including a cabinet forming an oven cavity, a broil heating element, and a bake heating element. A convection system develops a flow of air within and/or into the oven cavity. The convection heating system includes a motor-driven fan and a controllable switch for controlling an electrical power circuit for the motor. A user interface device allows for user selections of a convection bake operation and a convection roast operation. A controller communicates with the user interface device. The controller controls activations of the bake heating element and the fan. The controller has an output for controlling operations of the controllable switch. An isolation circuit provides electrical isolation between said output and the controllable switch. During the convection bake operation, the controller activates the bake element and controls the controllable switch so that the fan runs at a first speed. During the convection roast operation, the controller activates the bake element and controls the controllable switch so that the fan runs at a second speed that is higher than the first speed.

### BRIEF DESCRIPTION OF THE DRAWINGS

FIG. 1 is a perspective view of a cooking appliance;

FIG. 2 is a schematic block diagram;

FIG. 3 shows an example waveform;

FIG. 4 shows an example waveform; and

FIG. 5 is a schematic circuit diagram.

### DETAILED DESCRIPTION OF EXAMPLE EMBODIMENTS

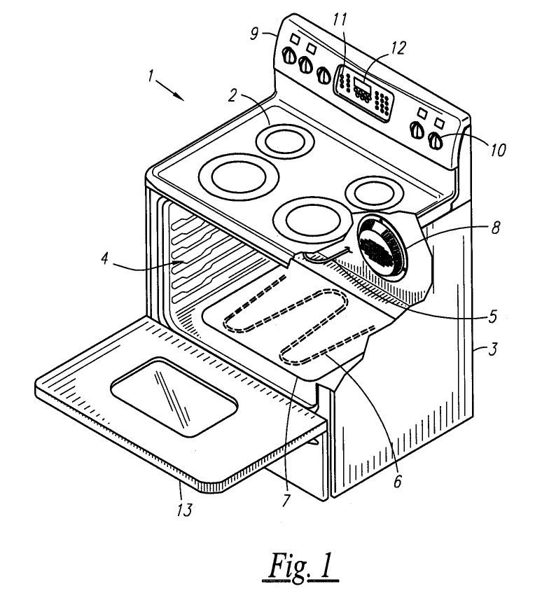

FIG. 1 shows an example cooking appliance 1. The cooking appliance is a free standing range having cooktop heating elements 2. A cabinet 3 forms an oven cavity 4. In an embodiment, the cooking appliance 1 is a so-called built-in oven for installation in a wall or cabinetry and having no cooktop surface and associated heating elements 2.

The cooking appliance 1 includes a broil element 5, which is partially shown in FIG. 1. The broil element 5 is mounted at an upper portion of the oven cavity 4. The appliance further includes a bake element 6 mounted at a lower portion of the oven cavity. In an embodiment, the bake element 6 is covered by a removable panel or plate 7, such as a porcelain plate. The removable panel 7 serves to hide the bake element 6 and provides a flat surface that is easily cleaned. The oven cavity 4 is accessible via a door 13, which is movable between a closed position and a not closed or open position.

The cooking appliance 1 of FIG. 1 is shown having electrical resistance heating elements. It is to be appreciated that the appliance 1 could alternatively have gas heating elements.

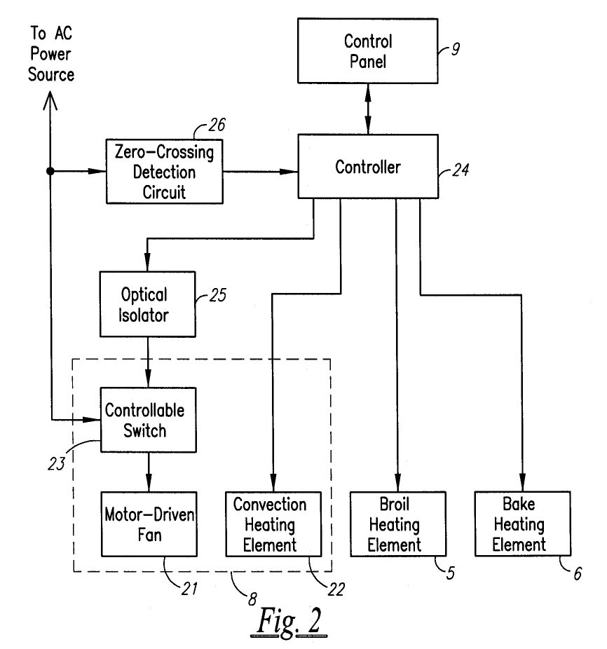

A convection heating system 8 develops convective air flows into and within the oven cavity 4. As shown schematically in FIG. 2, the convection heating system 8 includes a motor-driven fan 21 and, optionally, a convection heating element 22 located adjacent to the fan. The convection heating element 22 is an electrical resistance heating element. The convection heating system 8 may be located inside of the oven cavity 4 within a housing, or exterior to the oven cavity. The fan draws air from the oven cavity and pushes or pulls the air past the heating element and back into the oven cavity. Accordingly, the convection heating system 8 develops a flow of heated air into and within the oven cavity 4.

The convection heating system 8 further includes a controllable switch 23 for controlling an electrical power circuit for the fan's motor. The controllable switch 23 controls the conduction of electrical energy through the motor. A controller 24 controls the operation of the controllable switch 23. By controlling operations of the controllable switch 23, the controller 24 can control activations of the fan 21. Operation of the controllable switch 23 will be discussed in detail below. Example controllable switches include relays, transistors, thyristors, triacs, silicon-controlled rectifiers, and the like.

In an embodiment, the controller 24 controls the controllable switch 23 through an isolation circuit, such as an optical isolator 25. The isolation circuit provides electrical isolation between the controller's output and the controllable switch 23. The isolation circuit serves to isolate the lower voltage control output from the controller 24 from the higher voltage power circuit for the fan's motor, which is controlled by the controllable switch 23. An example optical isolator is model MOC3022M manufactured by FAIRCHILD SEMICONDUCTOR®.

Turning to FIG. 1, the convection heating system 8 is shown located centrally on a rear inner wall of the oven cavity 4. However, the convection heating system 8 could be provided at other locations within the oven cavity 4, such as along a side wall, for example. FIG. 1 shows a single convection heating system located within the oven cavity 4. It is to be appreciated that the appliance 1 can include additional convection heating systems controlled as discussed herein.

The cooking appliance 1 includes a control panel 9 comprising a plurality of user interface devices for allowing a user to control and monitor a cooking operation. The control panel includes a plurality of knobs 10 for activating and controlling the power level of the cooktop heating elements 2. The control panel 9 also includes a plurality of pushbuttons or touch-sensitive (e.g., capacitive) switches 11 (hereinafter referred to as “pushbuttons”) for activating and controlling various cooking operations within the oven cavity 4. For example, convection and non-convection baking operations, a broil operation, and a self-cleaning operation can be initiated by pressing appropriate pushbuttons 11, along with setting a desired cooking temperature. The control panel 9 further includes a display 12, such as a light emitting diode (LED) display or a liquid crystal display (LCD). The display 12 provides miscellaneous information to the user regarding the operation of the cooking appliance 1, such as remaining cooking time, temperature setting, etc. The display 12 can include a touch-screen for allowing the user to input information directly from the display 12.

FIG. 2 provides a schematic illustration of a control system for controlling activations of the bake heating element 6, the broil heating element 5 and the convection heating system 8. The controller 24 communicates with and/or monitors the interface devices on the control panel 9 and can control the activation and deactivation of the bake 6, broil 5 and convection 22 heating elements and the fan 21 based on user inputs. The controller 24 can include a plurality of logic circuits, and can include a programmable device, such as a microprocessor, for executing a program. The controller 24 can control operations of a plurality of controllable switches (not shown) for controlling activations of the bake 6, broil 5 and convection 22 heating elements. In an embodiment, the controller 24 monitors the position of the oven door 13 and deactivates the fan 21 and convection heating element 22 if the door 13 is in the open position.

Through the control panel 9, the user can select, among other things, a convection bake operation and a convection roast operation. During a convection bake operation, the controller 24 activates the bake element and controls the bake element to maintain a desired baking temperature. The controller 24 also activates the fan 21 and convection heating element 22. The controller 24 controls the controllable switch 23 so that the fan runs at a speed that is appropriate for convection baking. By controlling operations of the controllable switch 23, the controller can control fan speed in order to minimize undesirable crusting or glazing of baked goods (e.g., breads or cakes) during the convection baking process. An example fan speed for the convection bake operation is 1500 revolutions per minute (rpm). During the convection bake operation, the fan 21 and convection heating element 22 can be run continuously for the entire cooking operation or a portion thereof, or run intermittently, for example, pulsed ON and OFF.

During a convection roast operation, the controller 24 activates the bake element and controls the bake element to maintain a desired roasting temperature. The controller 24 also activates the fan 21 and convection heating element 22. The controller 24 controls the controllable switch 23 so that the fan runs at a speed that is appropriate for convection roasting. Typically, the fan operates at a higher speed during the convection roast operation than it does during the convection bake operation. An example fan speed for the convection roast operation is 2350 rpm. During the convection roast operation, the fan 21 and convection heating element 22 can be run continuously for the entire cooking operation or a portion thereof, or run intermittently, for example, pulsed ON and OFF.

In an embodiment, the user can change and program specific fan speeds for the convection bake and convection roast operations via the interface devices on the control panel 9.

The convection bake and convection roast operations can include food-specific convection cooking operations. Example food-specific cooking operations include convection bake bread, convection bake cake, convection bake pie, convection bake cookies, convection roast beef, convection roast turkey, convection roast chicken, etc. Each food-specific cooking operation has an associated fan speed, which can be a unique fan speed. The associated fan speed can be optimized for the specific food item to be cooked so that undesirable properties caused by the convection cooking process (e.g., crusting or glazing) are minimized.

During a cooking operation, for example, during the convection bake operation, the fan 21 can initially be run at a high initial speed then slowed to a desired speed for the duration of the cooking operation. Running the fan 21 at a high initial speed, for example for 5 seconds, then slowing the fan to a desired speed would help ensure proper starting of the fan's motor.

As shown in FIG. 2, the power source for the fan's motor is an alternating current (AC) power source, for example, a 120 or 240 VAC single phase power source. However, it is to be appreciated that the motor could be a direct current (DC) motor powered by a DC power source.

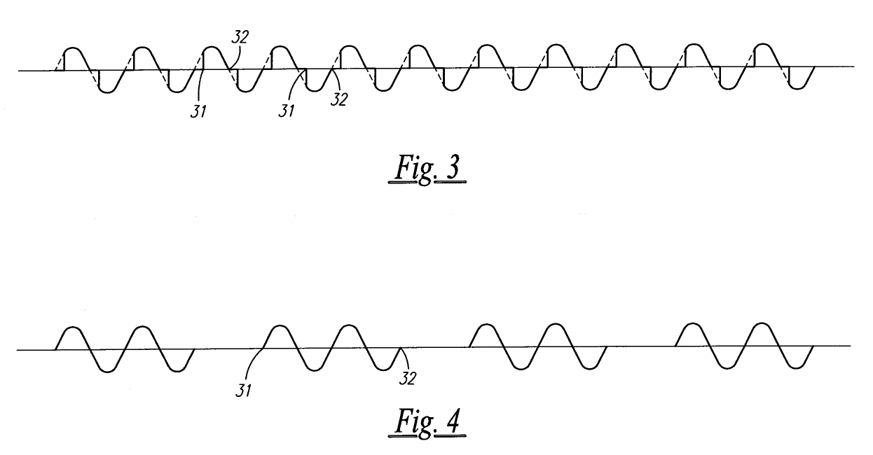

With reference to FIGS. 2-4, a system and method for controlling the speed of the motor-driven fan 21 will be discussed. The appliance 1 includes a zero-crossing detection circuit 26. The zero-crossing detection circuit 26 monitors the AC power source and generates an output signal, for example, a pulse, based on the zero voltage crossings of the power source's AC waveform. The controller 24 monitors the output signal from the zero-crossing detection circuit 26 and controls the controllable switch 23 based on the monitored output signal. The controller 24 synchronizes its operation of the controllable switch 23 with the output signal from the zero-crossing detection circuit 26. The controller 24 can cause power to the motor to be switched ON and OFF at specific points on the AC waveform. As shown in FIG. 3, electrical power can be supplied to the motor during selected portions of the waveform. The controllable switch 23, for example, a triac, is switched ON at point 31. The switch 23 switches OFF at the zero-crossing point 32. By performing phase control synchronized to the output signal from the zero-crossing detection circuit 26, the controller 24 controls the point on the AC waveform at which the triac is switched ON and, therefore, is capable of controlling the speed of the motor.

An alternative to phase control is shown in FIG. 4. The controller 24 causes the controllable switch 23 to conduct power to the motor for selected whole cycles of the AC waveform. Speed control is achieved by keeping the switch 23 OFF for selected whole cycles, for example, every 3rd cycle as shown in FIG. 4. The controllable switch 23 is switched ON at point 31, and remains on for two whole cycles. The controllable switch 23 switches OFF at point 32, and remains OFF for one whole cycle. Accordingly, every third cycle is removed by the controllable switch 23. Whole cycles can be removed as desired, for example every 3rd cycle can be removed, or every 8th cycle can be removed, etc. The more whole cycles removed, the slower the fan runs.

As discussed above, the fan 21 can initially be run at a high initial speed then slowed to a desired speed for the duration of the cooking operation. During a cooking operation in which the fan 21 is run at less than maximum speed, maximum voltage can initially be applied to the fan's motor so that the fan runs at the high initial speed, to ensure proper motor starting, then reduced using the techniques discussed above so that the fan 21 runs at the desired speed.

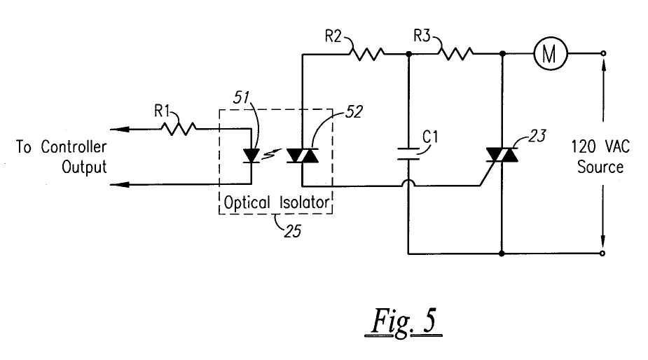

FIG. 5 shows an example schematic circuit diagram for implementing fan speed control as described above. An output from the controller is connected is connected to an LED emitter 51 in the optical isolator 25 through an input resistor R1. A detector 52 in the optical isolator 25 is responsive to the LED emitter 51. The detector 52 is connected to the controllable switch 23. In FIG. 5, the controllable switch 23 is a triac, and the detector 52 is connected to triac's gate. When the output from the controller activates the LED emitter 51, the detector 52 responds and applies a voltage to the triac's gate, turning the triac ON. When the triac is ON, current flows from the AC power source through the fan motor M and through the triac. Resistor R2 is connected to the detector 52 and limits surge currents through the detector 52. Resistor R3 and capacitor C1 act as a snubber for the triac and detector 52.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A cooking appliance, comprising:
a cabinet forming an oven cavity;
a broil heating element;
a bake heating element;
a convection heating system for developing a flow of heated air within the oven cavity, wherein the convection heating system includes:
a motor-driven fan;
a convection heating element located adjacent to the fan; and
a controllable switch for controlling an electrical power circuit for the motor;
a user interface device for allowing user selections of a convection bake operation and a convection roast operation; and
a controller in communication with the user interface device, wherein
the controller controls activations of the fan and said heating elements, and wherein
the controller has an output for controlling operations of the controllable switch, and wherein
during the convection bake operation the controller activates the bake and convection heating elements and controls the controllable switch so that the fan runs at a first speed, and wherein
during the convection roast operation the controller activates the bake and convection heating elements and controls the controllable switch so that the fan runs at a second speed that is higher than the first speed.

2. The cooking appliance of claim 1, wherein during the convection bake operation the fan initially runs at an initial speed that is higher than said first speed.

3. The cooking appliance of claim 1, wherein during at least one of the convection bake operation and the convection roast operation the fan runs intermittently.

4. The cooking appliance of claim 1, further comprising an isolation circuit for providing electrical isolation between said output and the controllable switch.

5. The cooking appliance of claim 4, further comprising a door moveable between an open position and a closed position, wherein the controller deactivates the fan and the convection heating element if the door is in the open position.

6. The cooking appliance of claim 4, wherein the isolation circuit includes an optical isolator.

7. The cooking appliance of claim 6, wherein the controllable switch is a triac.

8. The cooking appliance of claim 7, further comprising a zero-crossing detection circuit for monitoring an alternating current electrical source and generating an output signal, wherein
the controller monitors the output signal from the zero-crossing detection circuit, and wherein
the controller controls the controllable switch based on the monitored output signal from the zero-crossing detection circuit so that alternating current electrical power is supplied to the motor through the controllable switch during selected portions of an alternating current waveform of said electrical source.

9. The cooking appliance of claim 7, further comprising a zero-crossing detection circuit for monitoring an alternating current electrical source and generating an output signal, wherein
the controller monitors the output signal from the zero-crossing detection circuit, and wherein
the controller controls the controllable switch based on the monitored output signal from the zero-crossing detection circuit so that alternating current electrical power is supplied to the motor through the controllable switch during selected cycles of an alternating current waveform of said electrical source.

10. A cooking appliance, comprising:
a cabinet forming an oven cavity;
a broil heating element;
a bake heating element;
a convection system for developing a flow of air within the oven cavity, wherein the convection system includes a motor-driven fan and a controllable switch for controlling an electrical power circuit for the motor;
a user interface device for allowing user selections of a convection bake operation and a convection roast operation;
a controller in communication with the user interface device, wherein the controller controls activations of the bake heating element and the fan, and wherein the controller has an output for controlling operations of the controllable switch; and
an isolation circuit for providing electrical isolation between said output and the controllable switch, wherein
during the convection bake operation the controller activates the bake element and controls the controllable switch so that the fan runs at a first speed, and wherein
during the convection roast operation the controller activates the bake element and controls the controllable switch so that the fan runs at a second speed that is higher than the first speed.

11. The cooking appliance of claim 10, wherein during the convection bake operation the fan initially runs at an initial speed that is higher than said first speed.

12. The cooking appliance of claim 10, wherein during at least one of the convection bake operation and the convection roast operation the fan runs intermittently.

13. The cooking appliance of claim 10, wherein the convection system includes a convection heating element located adjacent to the fan, and further wherein the controller controls activations of the convection heating element.

14. The cooking appliance of claim 13, further comprising a door moveable between an open position and a closed position, wherein the controller deactivates the fan and the convection heating element if the door is in the open position.

15. The cooking appliance of claim 14, wherein the isolation circuit includes an optical isolator.

16. The cooking appliance of claim 15, wherein the controllable switch is a triac.

17. The cooking appliance of claim 10, wherein the isolation circuit includes an optical isolator.

18. The cooking appliance of claim 17, wherein the controllable switch is a triac.

19. The cooking appliance of claim 18, further comprising a zero-crossing detection circuit for monitoring an alternating current electrical source and generating an output signal, wherein
the controller monitors the output signal from the zero-crossing detection circuit, and wherein
the controller controls the controllable switch based on the monitored output signal from the zero-crossing detection circuit so that alternating current electrical power is supplied to the motor through the controllable switch during selected portions of an alternating current waveform of said electrical source.

20. The cooking appliance of claim 18, further comprising a zero-crossing detection circuit for monitoring an alternating current electrical source and generating an output signal, wherein
the controller monitors the output signal from the zero-crossing detection circuit, and wherein
the controller controls the controllable switch based on the monitored output signal from the zero-crossing detection circuit so that alternating current electrical power is supplied to the motor through the controllable switch during selected cycles of an alternating current waveform of said electrical source.

21. A cooking appliance, comprising:
a cabinet forming an oven cavity;
a broil heating element;
a bake heating element;
a convection system for developing a flow of air into the oven cavity, wherein the convection system includes a motor-driven fan and a controllable switch for interrupting electrical power for the motor;
a user interface device for allowing user selections of a convection bake operation and a convection roast operation;
a controller in communication with the user interface device, wherein the controller controls activations of the bake heating element and the fan, and wherein the controller has an output for controlling operations of the controllable switch, and
an isolation circuit for providing electrical isolation between said output and the controllable switch, wherein
during the convection bake operation the controller activates the bake element and controls the controllable switch so that the fan runs at a first speed, and wherein
during the convection roast operation the controller activates the bake element and controls the controllable switch so that the fan runs at a second speed that is higher than the first speed.

22. The cooking appliance of claim 21, wherein during the convection bake operation the fan initially runs at an initial speed that is higher than said first speed.

23. The cooking appliance of claim 21, wherein the isolation circuit includes an optical isolator.

24. The cooking appliance of claim 23, wherein the controllable switch is a triac.

25. The cooking appliance of claim 24, further comprising a zero-crossing detection circuit for monitoring an alternating current electrical source and generating an output signal, wherein
the controller monitors the output signal from the zero-crossing detection circuit, and wherein
the controller controls the controllable switch based on the monitored output signal from the zero-crossing detection circuit so that alternating current electrical power is supplied to the motor through the controllable switch during selected portions of an alternating current waveform of said electrical source.

26. The cooking appliance of claim 24, further comprising a zero-crossing detection circuit for monitoring an alternating current electrical source and generating an output signal, wherein
the controller monitors the output signal from the zero-crossing detection circuit, and wherein
the controller controls the controllable switch based on the monitored output signal from the zero-crossing detection circuit so that alternating current electrical power is supplied to the motor through the controllable switch during selected cycles of an alternating current waveform of said electrical source.
